(19) United States
(12) Patent Application Publication
(10) Pub. No.: US 2013/0251367 A1
(43) Pub. Date: Sep. 26, 2013

(54) CONTROL METHOD, OPTICAL TRANSMISSION DEVICE, AND CONTROL DEVICE FOR OPTICAL TRANSMISSION SYSTEM, AND OPTICAL TRANSMISSION SYSTEM

(71) Applicant: FUJITSU LIMITED, Kawasaki-shi (JP)

(72) Inventors: Shigeru Ishii, Shinagawa (JP); Yasushi Sugaya, Kawasaki (JP)

(73) Assignee: FUJITSU LIMITED, Kawasaki-shi (JP)

(21) Appl. No.: 13/751,578

(22) Filed: Jan. 28, 2013

(30) Foreign Application Priority Data
Mar. 23, 2012 (JP) 2012-067440

(51) Int. Cl. H04B 10/50

(52) U.S. Cl. CPC H04B 10/50
USPC 398/48; 398/182

(57) ABSTRACT

An optical transmission device includes: a controller that controllably extends a pass band of an optical transmission path for transmission of a known symbol sequence; and a transmission processing unit that provides the known symbol sequence after the controller controllably extends the pass band.

### CROSS-REFERENCE TO RELATED APPLICATION

This application is based upon and claims the benefit of priority of the prior Japanese Patent Application No. 2012-067440, filed on Mar. 23, 2012, the entire contents of which are incorporated herein by reference.

### FIELD

The embodiments discussed herein are related to a control method, optical transmission device, and control device for an optical transmission system, and to an optical transmission system.

### BACKGROUND

In recent years, as the quality of transmission data becomes high, the bit rate of a signal has to increase in an optical transmission system or so on that adopts wavelength division multiplexing (WDM) technology. In addition, as the volume of data increases, the frequency of a signal is becoming high.

On the other hand, high volume transmission is achieved by reducing the channel arrangement interval of wavelength-multiplexed signal light and narrowing the bandwidth for each channel to improve the use efficiency of frequencies.

When high-speed transmission with a transmission rate of, for example, 40 Gbps, 100 Gbps, or so on is achieved in such an optical transmission system, it is not possible to neglect effects of transmission quality degradation factors such as polarization mode dispersion, wavelength dispersion, and so on caused by the transmission path characteristics of an optical transmission path.

As an example of a method for suppressing effects of the above transmission quality degradation factors, for example, studies of digital coherent signal processing technology for digital processing of signal light have been done.

The technologies desired to achieve an optical transmission device that adopts digital coherent signal processing technology include a technology for estimating signal degradation caused when signal light is transmitted in an optical transmission path, a technology for identifying and compensating the cause of signal degradation based on the estimation result, a technology for correcting a code error, and so on.

As a technology for estimating signal degradation caused when signal light is transmitted in an optical transmission path among the above technologies, there is, for example, a method for estimating signal degradation by sending a known symbol sequence (also referred to below as a training signal) via an optical transmission path and comparing between the sent and received data.

During, for example, addition (rise) or so on of a signal, before signal light is transmitted or received, a training signal is transmitted via an optical transmission path and the transmission path characteristics of the optical transmission path are estimated based on comparison between the sent and received data. Then, based on the estimation result, initial parameters for digital signal processing in the optical transmission device are set.

International Publication Pamphlet No. WO 2006/137138 describes, as a related-art technology, for example, a method that transmits a fixed data row in which 0 and 1 alternation data and consecutive 0 and consecutive 1 alternation data including consecutive 0's and consecutive 1's alternately in an optical transmission path, lets a receiver determine the increase/decrease direction of the amount of dispersion compensation based on the number of errors in 0 and 1 alternation data and the number of errors in consecutive 0 and consecutive 1 alternation data, and variably controls the amount of dispersion compensation of a tunable dispersion compensator.

As described above, for signal light, the use efficiency of frequencies is improved and large volume transfer is achieved by narrowing the bandwidth of each channel.

When using this method, there is a case in which the bandwidth of a training signal used to estimate the transmission path characteristics of the optical transmission path may be larger than the bandwidth of signal light.

In this case, the training signal may suffer a loss depending on the pass band for optical transmission devices through which the training signal passes.

### SUMMARY

If the training signal suffers a loss, the transmission path characteristics of the optical transmission path does not be estimated appropriately and initial parameters for digital signal processing does not be set appropriately.

In such a case, the signal light may degrade and the signal light may be transmitted incorrectly.

According to an aspect of the embodiments, an optical transmission device includes: a controller that controllably extends a pass band of an optical transmission path for transmission of a known symbol sequence; and a transmission processing unit that provides the known symbol sequence after the controller controllably extends the pass band.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 depicts an example of the structure of an optical transmission system;

FIG. 2 depicts an example of the structure of an optical node depicted in FIG. 1;

FIG. 3 depicts an example of the structure of a wavelength selective switch depicted in FIG. 2;

FIGS. 4A to 4C depict an example of changing the pass band of the wavelength selective switch;

FIG. 5 depicts another example of the structure of the wavelength selective switch;

FIG. 6 depicts another example of the structure of the wavelength selective switch;

FIG. 7 depicts an example of a control method according to an embodiment;

FIG. 8 depicts an example of a control method according to a first modification;

FIG. 9 depicts an example of a control method according to the first modification;

FIG. 10 depicts an example of pass band characteristics of a variable bandwidth wavelength selective switch;

FIG. 11 depicts an example of pass band characteristics of a LCOS wavelength selective switch;

FIG. 12 depicts an example of arrangement of ports of the wavelength selective switch;

FIG. 13 depicts an example of input/output settings of the wavelength selective switch;

FIG. 14 depicts another example of the structure of the optical transmission system;

FIG. 15 depicts an example of pass band characteristics for each channel of the optical nodes of the optical transmission system depicted in FIG. 14;

FIG. 16A depicts an example of the structure of the optical transmission system;

FIGS. 16B to 16D depict an example of a control method according to the first modification;

FIG. 17 depicts an example of the structure of an optical transmission system according to a second modification;

FIG. 18 depicts an example of the structure of a network management device;

FIG. 19 depicts an example of a control method according to the second modification; and

FIG. 20 depicts an example of a control method according to the second modification.

### DESCRIPTION OF EMBODIMENTS

An embodiment of the present disclosure is described with reference to the drawings. However, the following embodiment is only an example and the application of numerous variations and techniques not described in the following embodiment and modifications are allowed. That is, it is clear that the embodiment and modifications can be changed and applied if there is no departure from the spirit of the present disclosure.

### 1 Embodiments

1.1 Example of the Structure of an Optical Transmission System

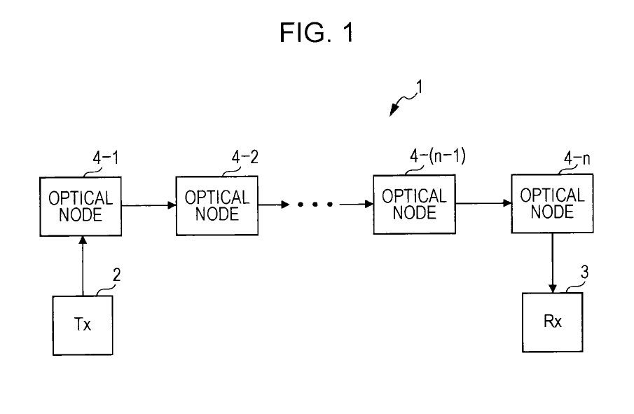

FIG. 1 depicts an example of the structure of an optical transmission system according to an embodiment.

The optical transmission system 1 depicted in FIG. 1 includes an optical node 4-1 having an optical transmitter (Tx) 2, optical nodes 4-2 to 4-(n−1) that relay signal light from the optical node 4-1, and an optical node 4-n having an optical receiver (Rx) 3, as an example (n indicates an integer equal to or more than 2). In FIG. 1, the Tx 2 in the optical node 4-1 and the Rx 3 in the optical node 4-n are depicted externally for convenience of explanation. When the optical nodes 4-1 to 4-n are not distinguished from each other, these nodes are simply referred to below as the optical node 4.

In the example depicted in FIG. 1, signal light sent from the Tx 2 is added by the optical node 4-1 to wavelength-multiplexed signal light transmitted in an optical transmission path, passes through the optical nodes 4-2 to 4-(n−1), is split (dropped) by the optical node 4-n, and is received by the Rx 3. The network topology of the optical transmission system 1 illustrated in FIG. 1 is only an example and the optical transmission system 1 may be ring-shaped, mesh-shaped, star-shaped, of fully-connected type, bus-shaped, tree-shaped, or so on. The optical transmission system 1 may have a network topology formed by combination of these network topologies.

Each of the optical nodes 4 functioning as an example of an optical transmission device has, for example, a wavelength selective switch (WSS) for passing, adding, or splitting signal light in units of the wavelength.

1.2 Example of the Structure of the Optical Node 4

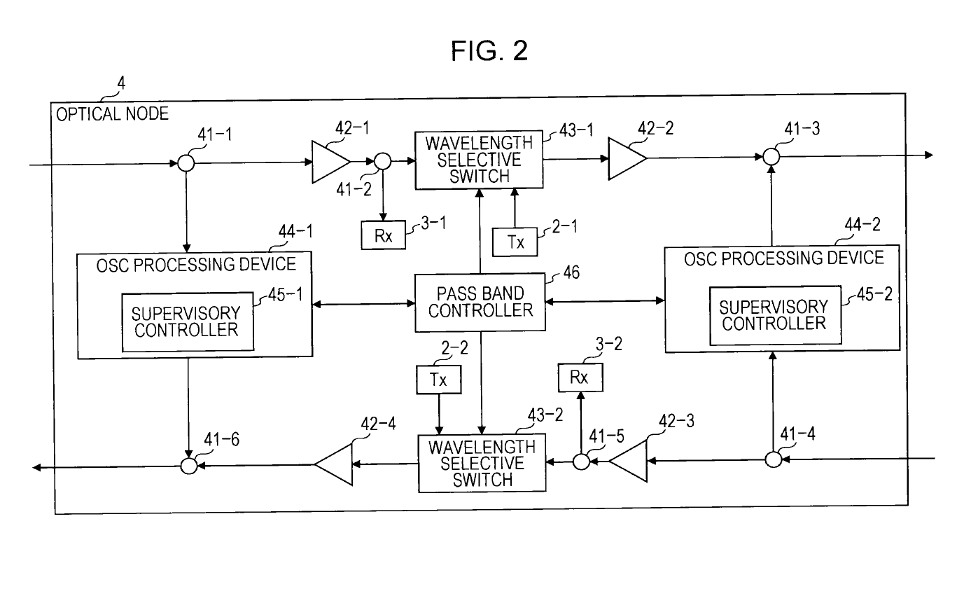

FIG. 2 depicts an example of the structure of the optical node 4. The optical node 4 depicted in FIG. 2 has an optical coupler 41-1, an optical amplifier 42-1, an optical coupler 41-2, an optical receiver (Rx) 3-1, a WSS 43-1, an optical transmitter (Tx) 2-1, an optical amplifier 42-2, and an optical coupler 41-3, as an example. The optical node 4 depicted in FIG. 2 further has an optical coupler 41-4, an optical amplifier 42-3, an optical coupler 41-5, an optical receiver (Rx) 3-2, a WSS 43-2, an optical transmitter (Tx) 2-2, an optical amplifier 42-4, and an optical coupler 41-6, as an example. The optical node 4 depicted in FIG. 2 further has an optical supervisory channel (OSC) processing device 44-1 having a supervisory controller 45-1, an OSC processing device 44-2 having a supervisory controller 45-2, and a pass band controller 46, as an example. The supervisory controller 45-1, the supervisory controller 45-2, and the pass band controller 46 may be achieved by using a common processor and a common memory and/or separate processors and separate memories. When the WSSes 43-1 and 43-2 are not distinguished from each other, these WSSes are simply referred to below as the WSS 43. For convenience of explanation, the direction from left to right in FIG. 2 may be referred to as an uplink direction and the direction from right to left may be referred to as a downlink direction.

Focusing on the uplink direction in the optical node 4 illustrated in FIG. 2, wavelength-multiplexed signal light input from an optical transmission path such as an optical fiber to the optical node 4 is power-split by the optical coupler 41-1 into a route to the optical amplifier 42-1 and a route to the OSC processing device 44-1.

The wavelength-multiplexed signal light power-split into the route to the optical amplifier 42-1 is amplified by the optical amplifier 42-1 and further power-split by the optical coupler 41-2. The signal light with a desired wavelength is selectively split (dropped) and received by at least one Rx 3-1. The Rx 3-1 may include a digital circuit and the “digital circuit” may include a digital signal processor (DSP) that performs digital signal processing of the signal light.

The wavelength-multiplexed signal light input from the optical coupler 41-2 to the WSS 43-1 is demultiplexed by the WSS 43-1 for each wavelength (channel), determined, for each channel, whether signal light is added to the wavelength-multiplexed signal light or the wavelength-multiplexed signal light is caused to pass through, wavelength-multiplexed again, and output to the optical amplifier 42-2. The signal light to be added is supplied to the WSS 43-1 by at least one Tx 2-1. The Tx 2-1 may include a digital circuit and the digital circuit may include a DSP that performs digital signal processing of signal light.

The wavelength-multiplexed signal light output from the WSS 43-1 is amplified by the optical amplifier 42-2, multiplexed with OSC light output from the OSC processing device 44-2 by the optical coupler 41-3, and output to the optical transmission path.

On the other hand, focusing on the downlink direction, wavelength-multiplexed signal light input from the optical transmission path such as an optical fiber to the optical node 4 is power-split by the optical coupler 41-4 into a route to the optical amplifier 42-3 and a route to the OSC processing device 44-2.

The wavelength-multiplexed signal light power-split into the route to the optical amplifier 42-3 is amplified by the optical amplifier 42-3 and further power-split by the optical coupler 41-5. Then, signal light with a desired wavelength is selectively split (dropped) and the wavelength-multiplexed signal light is received by at least one Rx 3-2. The Rx 3-2 may include a digital circuit and the digital circuit may include a DSP that performs digital signal processing of the signal light.

The wavelength-multiplexed signal light input from the optical coupler 41-5 to the WSS 43-2 is demultiplexed by the WSS 43-2 for each wavelength (channel), determined, for each channel, whether signal light is added to the wavelength-multiplexed signal light or the wavelength-multiplexed signal light is caused to pass through, wavelength-multiplexed again, and output to the optical amplifier 42-4. The signal light to be added is supplied to the WSS 43-2 by at least one Tx 2-2. The Tx 2-2 may include a digital circuit and the digital circuit may include a DSP that performs digital signal processing of signal light.

The wavelength-multiplexed signal light output from the WSS 43-2 is amplified by the optical amplifier 42-4, multiplexed with OSC light output from the OSC processing device 44-1 by the optical coupler 41-6, and output to the optical transmission path.

The OSC processing device 44-1 extracts OSC light included in the wavelength-multiplexed signal light power-split by optical coupler 41-1 and reports control information superimposed on the OSC light to the pass band controller 46. The OSC processing device 44-1 also superimposes control information reported from the pass band controller 46 on OSC light and outputs the control information to the optical coupler 41-6. Accordingly, the OSC processing device 44-1 has the supervisory controller 45-1, which extracts the control information superimposed on the OSC light and controls the transmission and reception of the control information.

Similarly, the OSC processing device 44-2 may extract OSC light included in the wavelength-multiplexed signal light power-split by optical coupler 41-4 and report control information superimposed on the OSC light to the pass band controller 46. The OSC processing device 44-2 may also superimpose control information reported from the pass band controller 46 on OSC light and output the control information to the optical coupler 41-3. The OSC processing device 44-2 may have a supervisory controller 45-2 that extracts the control information superimposed on the OSC light and controls the transmission and reception of the control information.

The above control information may include, for example, an alarm signal indicating occurrence of a failure in optical node 4, a control signal controlling amplification gains in the optical amplifiers 42-1 to 42-4, and a control signal controlling the attenuation in the WSS 43, etc. The supervisory controllers 45-1 and 45-2 may report occurrence of a failure to a network management system (NMS), control amplification gains in the optical amplifiers 42-1 to 42-4, or control the attenuation in the WSS 43, based on the control information.

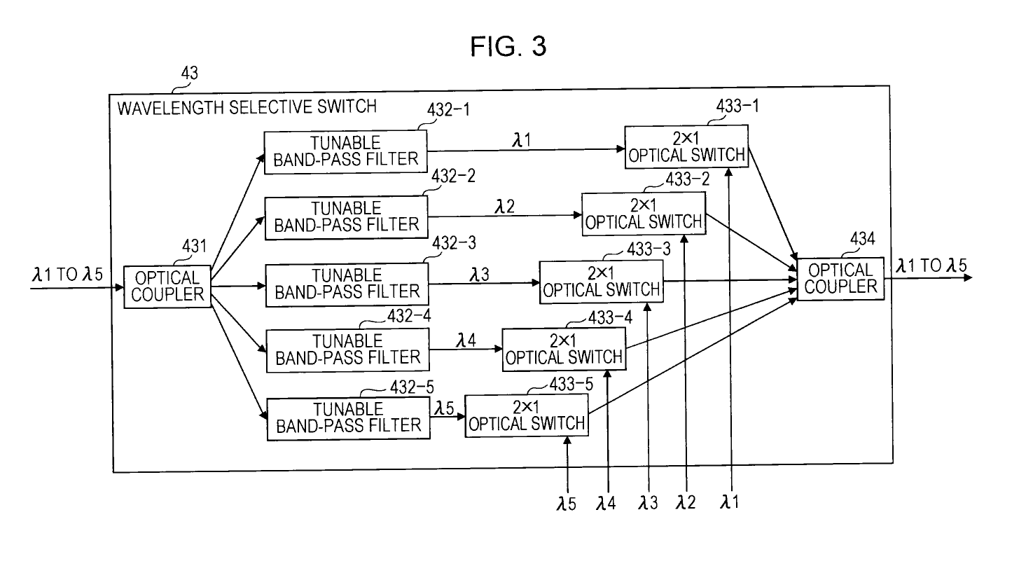

FIG. 3 depicts an example of the structure of the WSS 43.

As depicted in FIG. 3, the WSS 43 includes an optical coupler 431, tunable band-pass filters 432-1 to 432-5, 2×1 optical switches 433-1 to 433-5, and an optical coupler 434, as an example. The number of tunable band-pass filters and the number of 2×1 optical switches are not limited to the example in FIG. 3 and may be changed as appropriate depending on the wavelength-multiplicity of wavelength-multiplexed signal light to be input to the WSS 43.

When wavelength-multiplexed signal light in which signal light with five wavelengths (λ4 (channel 1) to λ5 (channel 5), λ1<λ2<λ3<λ4<λ5) is wavelength-multiplexed is input to the WSS 43 depicted in FIG. 3, the wavelength-multiplexed signal light is power-split by the optical coupler 431 and then input to the tunable band-pass filters 432-1 to 432-5.

The tunable band-pass filter 432-1 passes the signal light with wavelength λ1 and blocks the signal light with wavelengths λ2 to λ5. The tunable band-pass filter 432-1 is achieved by, for example, a low-pass filter or band-pass filter. The tunable band-pass filter 432-2 passes the signal light with wavelength λ2 and blocks the signal light with wavelengths λ1, λ3, λ4, and λ5. The tunable band-pass filter 432-2 is achieved by, for example, a band-pass filter. The tunable band-pass filter 432-3 passes the signal light with wavelength 23 and blocks the signal light with wavelengths λ1, λ2, λ4, and λ5. The tunable band-pass filter 432-3 is achieved by, for example, a band-pass filter. The tunable band-pass filter 432-4 passes the signal light with wavelength λ4 and blocks the signal light with wavelengths λ1, λ2, λ3, and λ5. The tunable band-pass filter 432-4 is achieved by, for example, a band-pass filter. The tunable band-pass filter 432-5 passes the signal light with wavelength λ5 and blocks the signal light with wavelengths λ1 to λ4. The tunable band-pass filter 432-5 is achieved by, for example, a high-pass filter or band-pass filter.

The 2×1 optical switch 433-1 selects either signal light with wavelength λ1 output from the tunable band-pass filter 432-1 or signal light with wavelength λ1 added from the Tx and outputs the selected light to the optical coupler 434. The 2×1 optical switch 433-2 selects either signal light with wavelength λ2 output from the tunable band-pass filter 432-2 or signal light with wavelength λ2 added from the Tx and outputs the selected light to the optical coupler 434. The 2×1 optical switch 433-3 selects either signal light with wavelength λ3 output from the tunable band-pass filter 432-3 or signal light with wavelength λ3 added from the Tx and outputs the selected light to the optical coupler 434. The 2×1 optical switch 433-4 selects either signal light with wavelength λ4 output from the tunable band-pass filter 432-4 or signal light with wavelength λ4 added from the Tx and outputs the selected light to the optical coupler 434. The 2×1 optical switch 433-5 selects either signal light with wavelength λ5 output from the tunable band-pass filter 432-5 or signal light with wavelength λ5 added from the Tx and outputs the selected light to the optical coupler 434.

The optical coupler 434 multiplexes signal light with wavelengths λ1 to λ5 output from the 2×1 optical switches 433-1 to 433-5 and outputs the light.

The WSS 43 may control the pass band for the signal light for each wavelength (channel) by, for example, changing the pass band of each of the tunable band-pass filters 432-1 to 432-5.

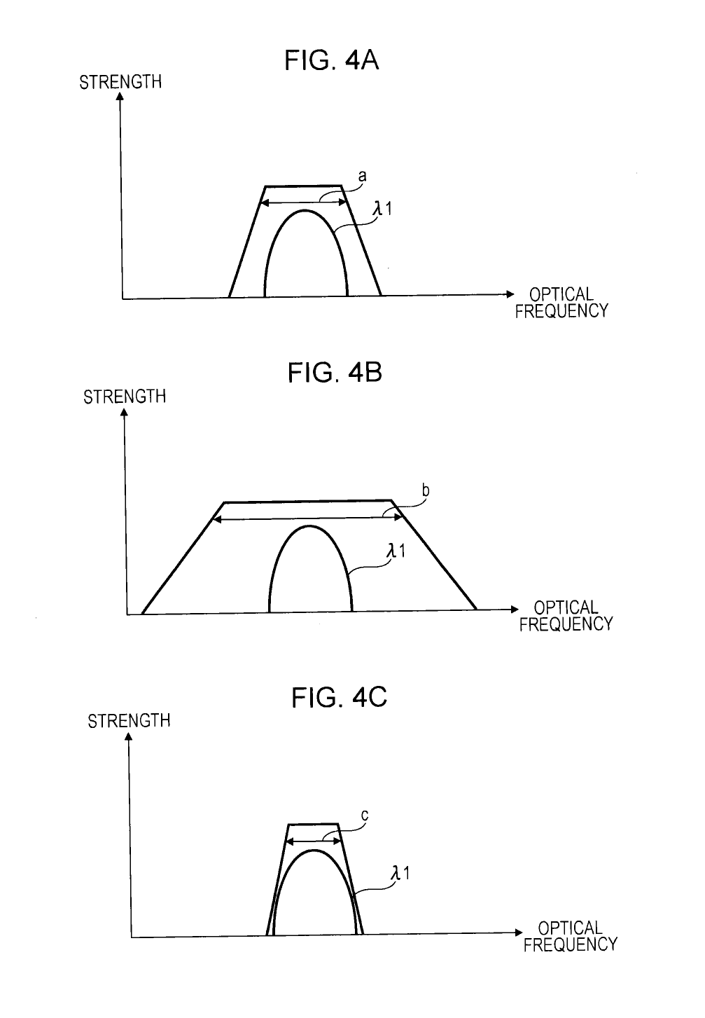

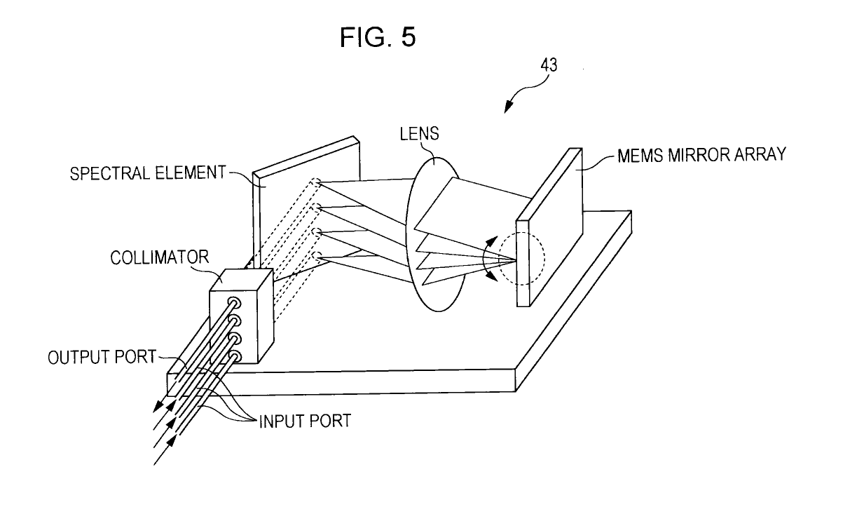

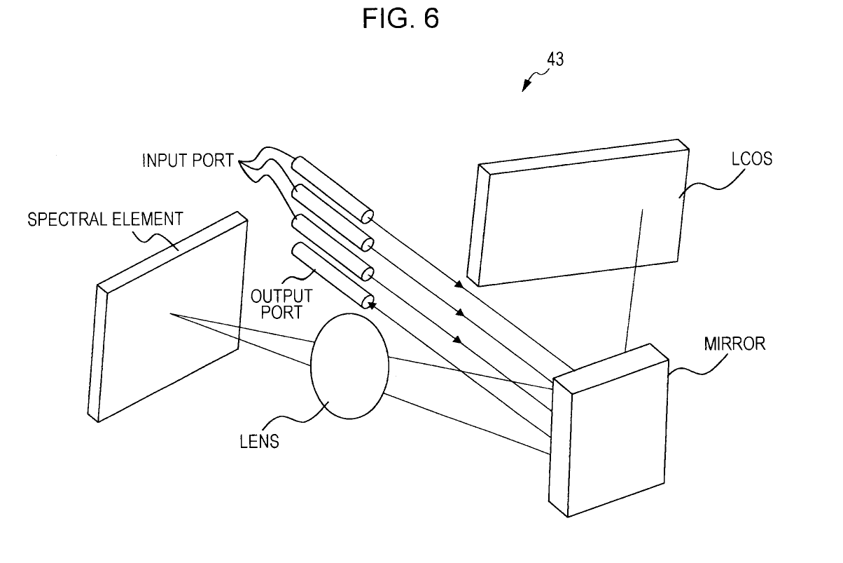

It is assumed that, for example, a certain pass band “a” is set for signal light with wavelength λ1 as illustrated in FIG. 4A. In this case, the pass band “a” may be extended to a pass band “b” as illustrated in FIG. 4B and the pass band “a” or the pass band “b” may be reduced to a pass band “c” as illustrated in FIG. 4C. This type of pass band control may be applied to the wavelength selective switch 43 including a MEMS (micro electro mechanical systems) mirror array as illustrated in FIG. 5 or the wavelength selective switch 43 including a LCOS (liquid crystal on silicon) as illustrated in FIG. 6 in addition to the WSS 43 with the structure illustrated in FIG. 3.

When signal light is subject to digital signal processing in the optical transmitters (Tx) 2-1 and 2-2 or the optical receivers (Rx) 3-1 and 3-2 in the optical node 4, parameters for digital signal processing may be set based on the estimation result of the transmission path characteristics of an optical transmission path.

During, for example, addition (rise) of a signal, before signal light is transmitted or received, a known symbol sequence (training signal) is transmitted in a channel in which signal light is transmitted or received via an optical transmission path, the transmission path characteristics of the optical transmission path are estimated based on the result of the transmission, and initial parameters for digital signal processing are set based on the estimation result. A series of steps regarding the setting of the initial parameters is simply referred to below as an initial process.

However, when the bandwidth of the signal light is smaller than that of the training signal, the pass band of the WSS 43 may have been set depending on the bandwidth of the signal light. In this case, the pass band of the WSS 43 is smaller than that of the training signal, so the training signal may suffer a loss. As a result, the transmission path characteristics of the optical transmission path are not estimated appropriately and initial parameters for digital signal processing are not set appropriately, so the signal light may degrade and the signal light may be transmitted incorrectly.

Accordingly, the pass band controller 46 in this example controllably extends the pass band of the WSS 43 depending on the bandwidth of the training signal before transmitting the training signal.

For example, the pass band controller 46 detects a channel for which the initial process is performed based on control information reported from the OSC processing devices 44-1 and 44-2, and controllably extends the pass band of this channel in the WSS 43.

That is, the pass band controller 46 functions as an example of a controller that controllably extends the pass band of the training signal before transmitting the training signal.

In addition, the wavelength selective switches 43-1 and 43-2 function as an example of a transmission processing unit that transmits the training signal in the optical transmission path after controllably extending the pass band.

This reduces the loss suffered by the training signal for estimating the transmission path characteristics of the optical transmission path so that the transmission path characteristics of the optical transmission path can be estimated exactly. As a result, initial parameters for digital signal processing can be set appropriately, and the signal light may be sent or received using the appropriately-estimated parameters.

1.3 Example of a Control Method

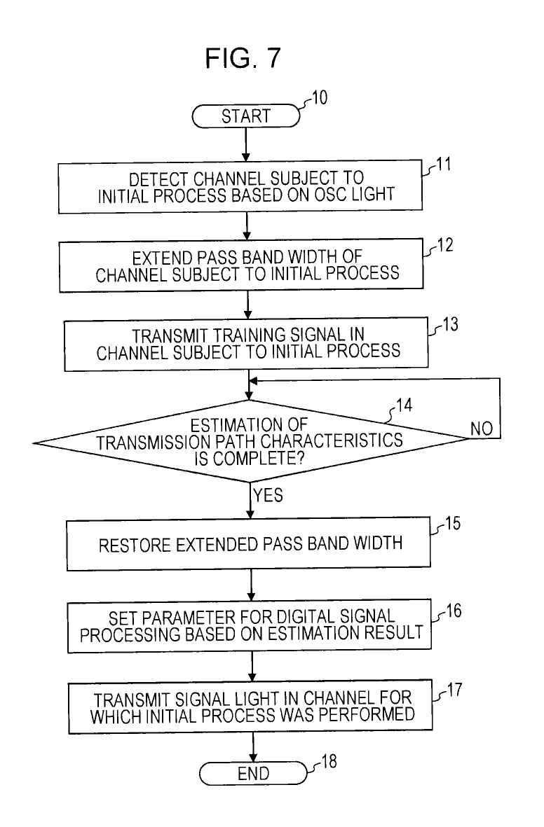

An example of a control method of the pass band of the WSS 43 is described with reference to FIG. 7.

As illustrated in FIG. 7, when control first starts during a rise or so on of a signal (operation 10), the pass band controller 46 detects a channel for which the initial process is performed, based on control information reported from the OSC processing devices 44-1 and 44-2 (operation 11). That is, the pass band controller 46 detects the channel to which a training signal is transmitted, based on control information reported from the OSC processing devices 44-1 and 44-2.

Then, the pass band controller 46 extends the pass band of the WSS 43 for the channel detected in operation 11 (operation 12). The extent to which the pass band of the WSS 43 is extended may be determined based on the bandwidth of the training signal to be transmitted. For example, the pass band of the WSS 43 may be extended so that the loss suffered by the training signal during passing becomes equal to or less than a predetermined threshold.

For example, the pass band of the channel detected in operation 11 may be extended to the pass band of an adjacent channel adjacent to the channel to achieve the processing in operation 12. This pass band may be controllably extended to the pass band of at least one of both adjacent channels to extend the pass band width of the training signal. In addition, the processing in operation 12 may be performed in the WSSes 43 of all optical nodes 4. Alternatively, while the processing in operation 12 is performed in optical nodes 4 in which at least one of both adjacent channels adjacent to the channel detected in operation 11 is not used, the processing in operation 12 may not be performed in optical nodes 4 other than the above optical nodes 4. If such a process is performed, effects of the expansion control of the pass band on other channels in the network path may be suppressed by controllably extending the pass band.

Next, the pass band controller 46 transmits the training signal in the channels with the extended pass band (operation 13). For example, the pass band controller 46 may start transmitting the training signal by reporting the completion of the processing in operation 12 to Tx in the optical node 4. For example, an alternation signal in which 0 and 1 appear alternately may be used as the training signal.

The Rx 3-1 and Rx 3-2 in the optical node 4, which receive the training signal, estimates the transmission path characteristics of the optical transmission path based on the transmission result of the training signal. At this time, the optical node 4 may estimate the transmission path characteristics exactly using a side band of the training signal for estimation of the transmission path characteristics.

Then, the pass band controller 46 decides whether the Rx 3-1 and Rx 3-2 in the optical node 4, which receive the training signal, have completed the estimation of the transmission path characteristics of the optical transmission path (operation 14). If the pass band controller 46 decides that the estimation of the transmission path characteristics of the optical transmission path is not complete (No in operation 14), the pass band controller 46 waits until the estimation of the transmission path characteristics of the optical transmission path is complete. The decision processing in operation 14 may be made through, for example, a report about the completion of the estimation of the transmission path characteristics of the optical transmission path from the device that makes the estimation.

On the other hand, if the pass band controller 46 decides that the estimation of the transmission path characteristics of the optical transmission path is complete (Yes in operation 14), the pass band controller 46 restores the extended pass band of the WSS 43 (operation 15).

Then, the pass band controller 46 sets parameters for digital signal processing in the local optical node 4 based on the transmission path characteristics of the optical transmission path estimated above (operation 16). The Rx 3-1 and Rx 3-2 may set parameters for digital signal processing in the local optical node 4 based on the transmission path characteristics of the optical transmission path estimated by the Rx 3-1 and Rx 3-2.

After setting the parameters, the optical node 4 transmits signal light (operation 17) in the channel for which the initial process was performed and ends control (operation 18).

The processing in the above operation 10 to operation 18 may be performed in all of the optical nodes 4 in which the signal light of the channel to be controlled is transmitted or may be performed in at least either of the optical nodes 4 in which the signal light of the channel to be controlled is transmitted.

As described above, in this example, the pass band of the training signal may be extended in the optical node 4 before the training signal for estimating the transmission path characteristics of the optical transmission path is transmitted in order to reduce the loss suffered by the training signal.

As a result, the transmission path characteristics of the optical transmission path can be estimated appropriately and parameters for digital signal processing can be set appropriately.

The pass band width of the training signal from the transmitter (Tx) to the receiver (Rx) depends on, for example, the number of optical nodes 4 through which the training signal passes.

Accordingly, in this example, a determination is made as to whether the pass band of the channel in which the training signal is transmitted is controllably extended depending on the number of optical nodes 4 through which the training signal passes. In addition, when the above control is performed, the pass band of the channel is controllably extended in part of the optical nodes 4 so that, for example, the loss suffered by the training signal becomes equal to or less than a predetermined threshold or the transmitted training signal satisfies a predetermined reception quality.

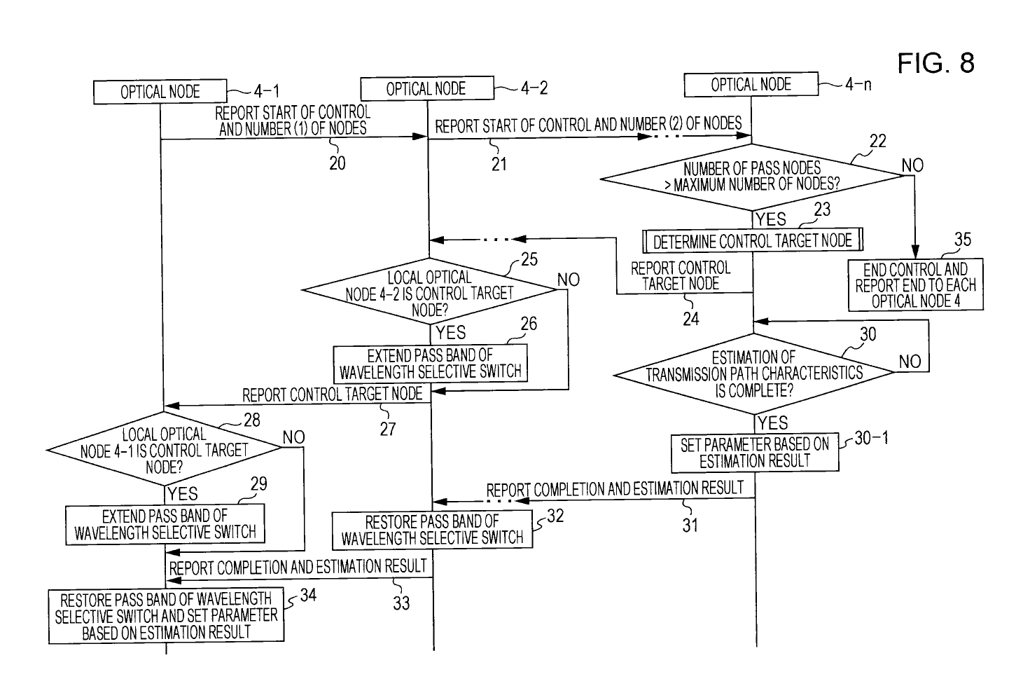

The control method in this example is described with reference to FIG. 8.

As illustrated in FIG. 8, when control first starts during a rise or so on of a signal in a certain channel, the optical node 4-1 from which the training signal is sent reports information depicting the start of control and information “1” about the number of pass nodes to the optical node 4-2 (operation 20).

When receiving the report from the optical node 4-1, the optical node 4-2 reports the information depicting the start of control and information “2” about the number of pass nodes to the next optical node 4-3 (operation 21).

Similarly, the optical nodes 4-3 to 4-(n−1) report the information depicting the start of control and information “3” to “n−1” about the number of pass nodes to the next optical nodes 4-4 to 4-n, respectively.

As described above, each optical node 4 increments information about the number of pass nodes by 1 and reports the information about the number of pass nodes to the next optical node 4 to report the number of optical nodes through which the training signal passes to the optical node 4-n, which receives the training signal.

The optical node 4-n obtains the number of optical nodes (the number of pass nodes) through which the training signal passes based on the reported information as described above and decides whether the number of pass nodes is more than the maximum number of nodes (operation 22). The maximum number of nodes represents, for example, the maximum number of pass nodes at which the loss suffered by the training signal becomes less than a predetermined threshold even if the pass band is not extended in a newly-open channel. The maximum number of nodes may be determined based on, for example, the result of actual measurement or simulation of the loss suffered by the training signal or the pass band width from the transmitter to the receiver.

If the optical node 4-n decides that the number of pass nodes is equal to or less than the maximum number of nodes (No in operation 22), the optical node 4-n ends the control and reports the end of the control to each optical node 4 (operation 35). When receiving the end of the control, each optical node 4 starts transmitting the training signal without extending the pass band of the WSS 43 and performs the initial process.

On the other hand, if the number of pass nodes is decided to be more than the maximum number of nodes (Yes in operation 22), the optical node 4-n decides that the loss suffered by the training signal becomes equal to or more than the predetermined threshold and determines the optical node (control target node) 4 for which the pass band is controllably extended (operation 23).

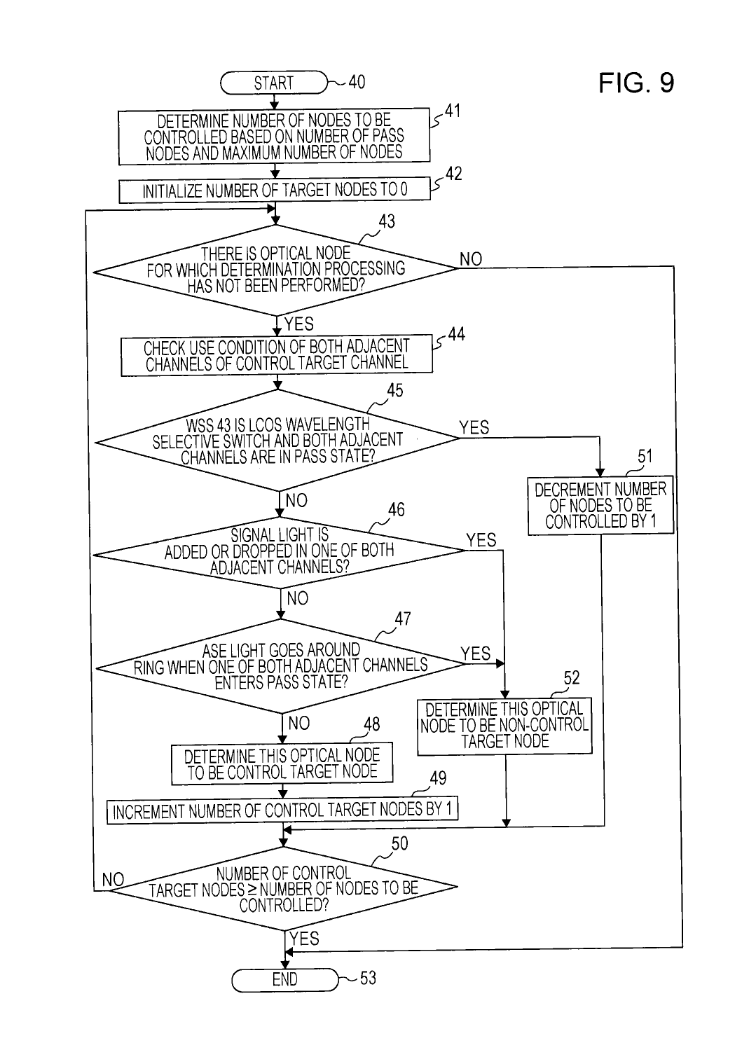

The control target node is selected from, for example, the optical nodes 4 that have no effects by controllably extending the pass band on other channels in the network path and is not restricted during control of devices. For example, control target node determination processing illustrated in FIG. 9 is performed.

As illustrated in FIG. 9, processing for determining a control target node first starts (operation 40), the optical node 4-n calculates the number (the number of nodes to be controlled) of optical nodes 4 whose pass bands are controllably extended based on the maximum number of nodes and the number of pass nodes (operation 41). For example, the optical node 4-n calculates the number of nodes to be controlled, by subtracting the maximum number of nodes from the number of pass nodes. The number of nodes to be controlled may be more than the value calculated by subtracting the maximum number of nodes from the number of pass nodes.

Next, the optical node 4-n initializes the number (the number of control target nodes) of optical nodes 4 whose pass bands have been determined to be controllably extended, to 0 (operation 42).

Before the optical node 4-n decides, for each optical node 4, whether the above control is performed, the optical node 4-n first decides whether there is an optical node 4 for which the determination processing has not been performed (operation 43).

If the determination processing has been performed for all of the optical nodes 4 (No in operation 43), the optical node 4-n ends the control target node determination processing (operation 53).

On the other hand, if there is an optical node 4 for which the determination processing has not been performed (Yes in operation 43), the optical node 4-n checks the use conditions of both adjacent channels adjacent to the channel (control target channel) in which the training signal is transmitted by analyzing, for example, channel monitoring information or so on for one optical node 4 of the optical nodes 4-1 to 4-n (operation 44).

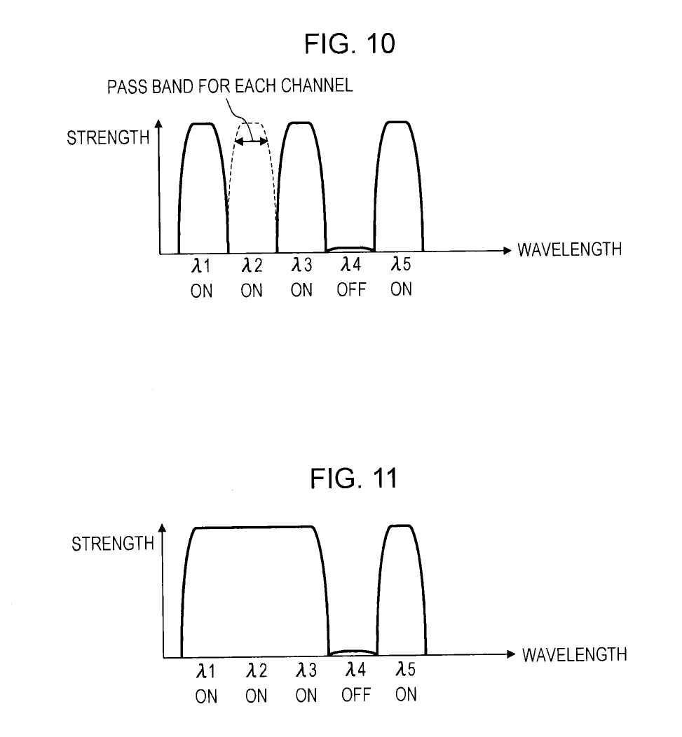

If the WSS 43 has a structure as illustrated in FIG. 3 or 5, even when both adjacent channels (for example, λ1 and λ3) adjacent to a control target channel (for example, λ2) are in the pass state (ON), there are wavelength points (valleys) in which the strength of the training signal is reduced, as illustrated in FIG. 10.

On the other hand, when the WSS 43 has a LCOS as illustrated in FIG. 6, when both adjacent channels (for example, λ1 and 23) adjacent to the control target channel (for example, λ2) are in the pass state (ON), there are no wavelength points (valleys) in which the strength of the training signal is reduced, as illustrated in FIG. 11.

Accordingly, when the WSS 43 is a LCOS wavelength selective switch and both adjacent channels adjacent to the control target channel are in the pass state, the pass band of the control target channel may be regarded to have been extended.

Accordingly, the optical node 4-n decides whether the WSS 43 is a LCOS wavelength selective switch and both adjacent channels adjacent to the control target channel are in the pass state (operation 45). If the WSS 43 is a LCOS wavelength selective switch and both adjacent channels adjacent to the control target channel are in the pass state (Yes in operation 45), the optical node 4-n decrements the number of nodes to be controlled by 1 (operation 51). If the WSS 43 is not a LCOS wavelength selective switch, the optical node 4-n may omit the processing in operation 45 and operation 51.

Then, the optical node 4-n decides whether the number of control target nodes is equal to or more than the number of nodes to be controlled (operation 50). If the number of control target nodes is equal to or more than the number of nodes to be controlled (Yes in operation 50), the optical node 4-n ends the control target node determination processing (operation 53). If the number of control target nodes is less than the number of nodes to be controlled (No in operation 50), the optical node 4-n lets the processing to return to operation 43.

On the other hand, if the WSS 43 is not a LCOS wavelength selective switch or if one of both adjacent channels adjacent to the control target channel is not in the pass state even if the WSS 43 is a LCOS wavelength selective switch (No in operation 45), the optical node 4-n decides whether an addition or drop of signal light has been performed in one of both adjacent channels adjacent to the control target channel (operation 46). For example, the optical node 4-n may collect setting information about the wavelength selective switch 43 of each optical node 4 and may decide whether an addition or drop of signal light has been performed in one of both adjacent channels adjacent to the control target channel based on the collected setting information. The setting information about the wavelength selective switch 43 includes, for example, information about the input/output destination of each channel in the wavelength selective switch 43. That is, each optical node 4 may have a function of sending the setting information of the local optical node 4 to an adjacent optical node 4 and a function of adding the setting information of the local optical node 4 to the setting information received from the optical node 4 adjacent to the local optical node 4 and sending the resulting setting information to the next optical node 4.

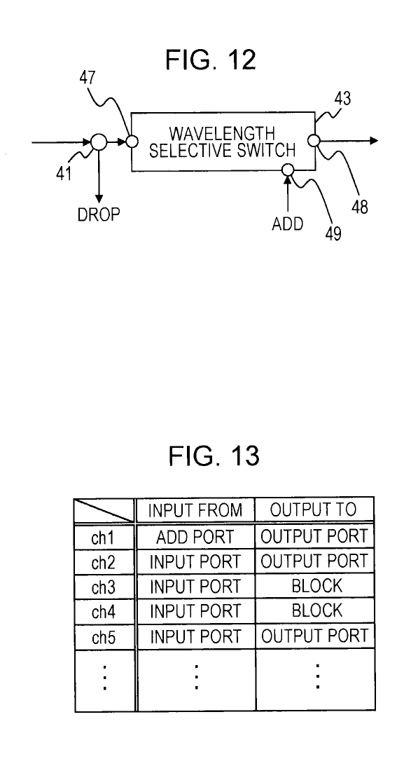

For example, when the WSS 43 has an input port 47 to which signal light is input from an optical coupler 41, an addition port 49 to which signal light is added, and an output port 48 from which signal light is output to an optical transmission path as depicted in FIG. 12 and has settings in which, for example, signal light in channel 1 is added, signal light in channel 2 and signal light in channel 5 pass through, signal light in channel 3 and signal light in channel 4 are dropped, then input/output settings as illustrated in FIG. 13 are made.

When channel 1 is adjacent to the control target channel in this case, if the pass state is set by controllably extending the pass band of the control target channel, signal light in channel 1 included in wavelength-multiplexed signal light is not blocked and signal light in channel 1 is not added from the optical node 4. Accordingly, in the optical node 4 for which channel 1 to be added is adjacent to the control target channel, it is desirable to avoid controllably extending the pass band of the control target channel.

When either channel 3 or channel 4 is adjacent to the control target channel, if the pass state is set by controllably extending the pass band of the control target channel, signal light in channel 3 and signal light in channel 4 included in wavelength-multiplexed signal light are transmitted to the next optical node 4. Accordingly, in the optical node 4 for which either of channels 3 and 4 to be dropped is adjacent to the control target channel, it is desirable to avoid controllably extending the pass band of the control target channel.

Therefore, if signal light is added or dropped in one of both adjacent channels adjacent to the control target channel (Yes in operation 46), the optical node 4-n determines the optical node 4 to be a non-control target node for which the pass band is not controllably extended (operation 52).

Then, the optical node 4-n decides whether the number of control target nodes is equal to or more than the number of nodes to be controlled (operation 50). If the number of control target nodes is equal to or more than the number of nodes to be controlled (Yes in operation 50), the optical node 4-n ends the control target node determination processing (operation 53). If the number of control target nodes is less than the number of nodes to be controlled (No in operation 50), the optical node 4-n lets the processing to return to operation 43.

On the other hand, if signal light is not added or dropped in any of both adjacent channels adjacent to the control target channel (No in operation 46), the optical node 4-n decides whether leak light such as amplified spontaneous emission (ASE) light goes around a ring network when one of both adjacent channels adjacent to the control target channel is controlled to enter the pass state (operation 47). For example, the optical node 4-n may collect setting information about the wavelength selective switch 43 of each optical node 4 and may decide whether signal light is added or dropped in one of both adjacent channels adjacent to the control target channel based on the collected setting information. The setting information about the wavelength selective switch 43 may include, for example, information about the input/output destination of each channel of the wavelength selective switch 43. That is, each optical node 4 may have a function of sending the setting information of the local optical node 4 to an adjacent optical node 4 and a function of adding the setting information of the local optical node 4 to the setting information received from the optical node 4 adjacent to the local optical node 4 and sending the resulting setting information to the next optical node 4.

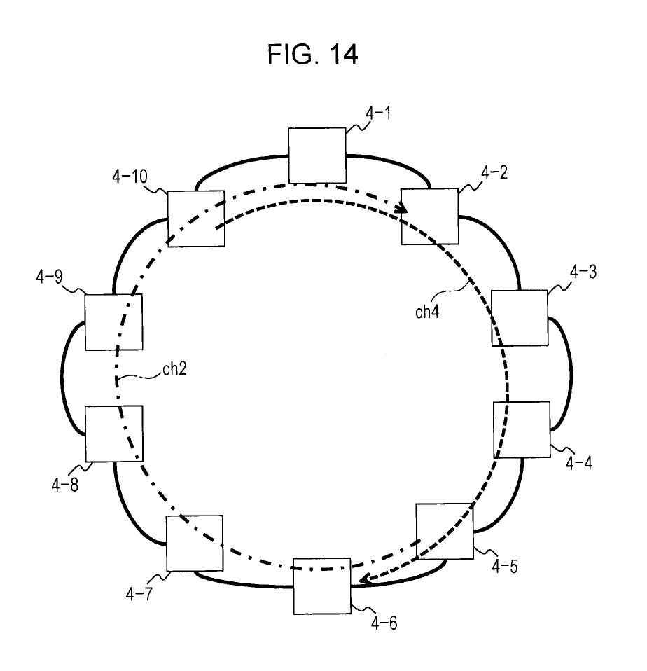

For example, it assumes that, as illustrated in FIG. 14, the optical transmission system 1 has a ring network in which the optical nodes 4-1 to 4-10 are connected annularly and, for example, signal light (see the dotted line arrow in FIG. 14) in channel 4 of contiguous channels 1 to 5 is added from the optical node 4-10, passes through the optical nodes 4-1 to 4-5, and is dropped in the optical node 4-6, while signal light (see the alternate long and short dashed line arrow in FIG. 14) in channel 2 is added from the optical node 4-5, passes through the optical nodes 4-6 to 4-10 and 4-1, and is dropped in the optical node 4-2.

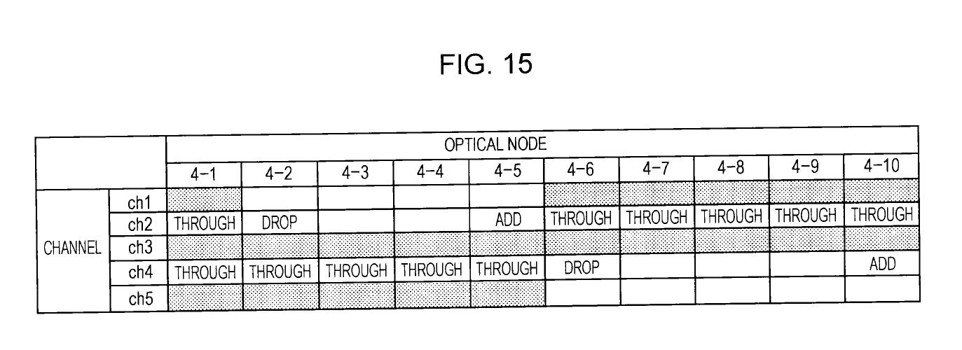

In such a case, as illustrated in FIG. 15, when both adjacent channels (channels 3 and 5) adjacent to channel 4 enter the pass state (see the shaded rows of channels 3 and 5 in the columns of the optical nodes 4-1 to 4-5 in FIG. 15) as a result of controllably extending the pass band of channel 4 to transmit the training signal in channel 4 and both adjacent channels (channels 1 and 3) adjacent to channel 2 enter the pass state (see the shaded rows of channels 1 and 3 in the columns of the optical nodes 4-6 to 4-10 and 4-1 in FIG. 15) as a result of controllably extending the pass band of channel 2 to transmit the training signal in channel 2, channel 3 of the optical nodes 4-1 to 4-10 enters the pass state and ASE light within the frequency band of channel 3 goes around the ring network and oscillates, possibly degrading the transmission performance of other channels.

Accordingly, in such a case (Yes in operation 47), the optical node 4-n determines this optical node 4 to be a non-control target whose pass band is not controllably extended (operation 52). If the optical transmission system 1 does not have a ring network, the optical node 4-n may omit the processing in operation 47.

Then, the optical node 4-n decides whether the number of control target nodes is equal to or more than the number of nodes to be controlled (operation 50). If the number of control target nodes is equal to or more than the number of nodes to be controlled (Yes in operation 50), the optical node 4-n ends the control target node determination processing (operation 53). If the number of control target nodes is less than the number of nodes to be controlled (No in operation 50), the optical node 4-n lets the processing to return to operation 43.

On the other hand, if it is decided that the optical transmission system 1 does not have a ring network or the training signal does not go around a ring network (that is, a go-around of the training signal in a ring network may be avoided) (No in operation 47), the optical node 4-n determines this optical node 4 to be a target whose pass band is controllably extended (operation 48) and increments the number of control target nodes by 1 (operation 49). The go-around above indicates that the training signal makes at least one revolution in a ring network.

Then, the optical node 4-n decides whether the number of control target nodes is equal to or more than the number of nodes to be controlled (operation 50). If the number of control target nodes is equal to or more than the number of nodes to be controlled (Yes in operation 50), the optical node 4-n ends the control target node determination processing (operation 53). If the number of control target nodes is less than the number of nodes to be controlled (No in operation 50), the optical node 4-n lets the processing to return to operation 43.

The information about the control target node determined as described above is superimposed on the monitoring control signal by the optical node 4-n and reported to the optical nodes 4-(n−1) to 4-2 in sequence via an OSC or so on (operation 24 in FIG. 8).

For example, when receiving information about the control target node, the optical node 4-2 decides whether the local optical node 4-2 is the control target node based on the information about the control target node (operation 25). If the optical node 4-2 decides that the local optical node 4-2 is the control target node (Yes in operation 25), the optical node 4-2 controllably extends the pass band of the WSS 43 (operation 26) and transmits the information about the control target node to the next optical node 4-1 (operation 27). If the WSS 43 in the optical node 4-2 is of LCOS type, the pass band of the control target channel may be extended by controllably setting the both adjacent channels adjacent to the control target channel in the pass state.

On the other hand, if the optical node 4-2 decides that the local optical node 4-2 is not the control target node (No in operation 25), the optical node 4-2 transmits the information about the control target node to the next optical node 4-1 without controllably extending the pass band of the WSS 43 (operation 27).

Similarly, when receiving the information about the control target node from the optical node 4-2, the optical node 4-1 decides whether the local optical node 4-1 is the control target node based on the information about the control target node (operation 28). If the optical node 4-1 decides that the local optical node 4-1 is the control target node (Yes in operation 28), the optical node 4-1 controllably extends the pass band of the WSS 43 (operation 29). If the WSS 43 in the optical node 4-1 is of LCOS type, the pass band of the control target channel may be extended by controllably setting both adjacent channels adjacent to the control target channel in the pass state, as in the optical node 4-2.

On the other hand, if the optical node 4-1 decides that the local optical node 4-1 is not the control target node (No in operation 28), the optical node 4-1 skips control for extending the pass band of the WSS 43.

When the pass band has been controllably extended as described above, the optical node 4-1 as an optical transmitter sends the known training signal via an optical transmission path and the optical node 4-n as an optical receiver receives the training signal sent from the optical node 4-1 and, based on the reception result, estimates the transmission path characteristics of the optical transmission path such as polarization mode dispersion and wavelength dispersion.

Next, the optical node 4-n decides whether the above estimation is complete (operation 30). If the optical node 4-n decides that the estimation is complete (Yes in operation 30), the optical node 4-n sets initial parameters for digital signal processing in the Rx (optical receiver) (operation 30-1). In addition, the optical node 4-n reports the completion of the estimation and the estimation result to the optical nodes 4-(n−1) to 4-2 (operation 31). Information about the completion of estimation and the estimation result may be superimposed on, for example, the monitoring control signal and may be reported via an OSC or so on. If the optical node 4-n decides that the estimation is not complete (No in operation 30), the optical node 4-n repeats the processing in operation 30 until the estimation is complete.

For example, when receiving information about the completion of estimation and the estimation result, the optical node 4-2 restores the pass band of the WSS 43 (operation 32) if the pass band was extended and forwards information about the completion of estimation and the estimation result to the next optical node 4-1 (operation 33).

Similarly, when receiving information about the completion of estimation and the estimation result from the optical node 4-2, the optical node 4-1 restores the pass band of the WSS 43 if the pass band was extended and, based on the received estimation result, sets initial parameters for digital signal processing in Tx (optical transmitter) (operation 34). Restoring the pass band of the WSS 43 means changing the pass band of the WSS 43 to a pass band for signal light. More specifically, if the bandwidth of the training signal is larger than that of signal light, the pass band of the WSS 43 extended for the training signal is narrowed to a pass band for signal light.

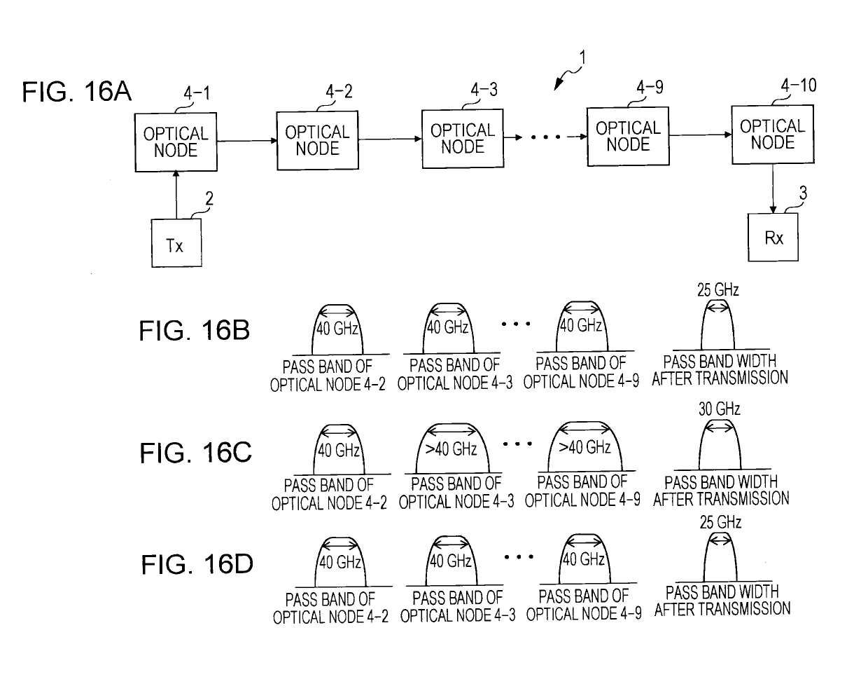

A specific example of the above control method is depicted in FIGS. 16A to 16D.

When the optical transmission system 1 has 10 optical nodes 4-1 to 4-10 as illustrated in FIG. 16A and the WSS 43 in each optical node 4 has a pass band of 40 GHz (Gaussian order 3) as the −3 dB bandwidth as illustrated in FIG. 16B, the pass band width requested during the initial process of a newly-open channel is assumed to be 30 GHz as the −3 dB bandwidth, for example.

However, when the training signal is transmitted with the WSS 43 in each optical node 4 remaining unchanged as depicted in FIG. 16B, the pass band width of the training signal in the Rx 3 after transmission becomes 25 GHz as the −3 dB bandwidth, which does not meet the requested pass band width 30 GHz.

Accordingly, this example may increase the pass band width of training signal in the Rx 3 after transmission to approximately 30 GHz, which is the requested pass band width, by performing, for example, the pass setting of both adjacent channels adjacent to the control target channel in which the training signal is transmitted in the WSSes 43 in any five optical nodes (for example, the optical nodes 4-3 to 4-6 and 4-9) of the optical nodes 4-1 to 4-10 in order to extend the pass band of the control target channel, as illustrated in FIG. 16C.

Upon completion of the initial process through the transmission of the training signal, the use efficiency of channels during transmission of signal light may be improved by restoring the pass band extended by the WSSes 43 in the optical nodes 4-3 to 4-6 and 4-9 as illustrated in FIG. 16D.

Although the above control is achieved by each optical node 4 using OSC light in the above embodiment and the first modification, the above control may also be achieved by, for example, a NMS using commands such as GMPLS (generalized multi-protocol label switching) and/or TL1 (transaction language 1).

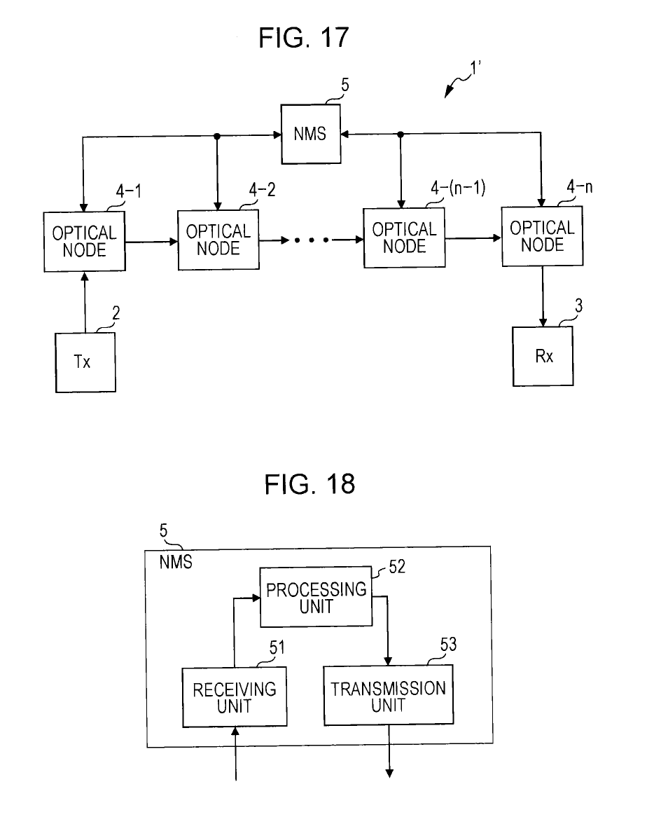

FIG. 17 depicts an example of the structure of an optical transmission system according to this example.

The optical transmission system 1′ depicted in FIG. 17 includes the optical node 4-1 having the optical transmitter (Tx) 2, the optical nodes 4-2 to 4-(n−1) that relay signal light from the optical node 4-1, the optical node 4-n having the optical receiver (Rx) 3, and the network management system (NMS) 5 that manages each optical node 4, as an example. In FIG. 17, the Tx 2 in the optical node 4-1 and the Rx 3 in the optical node 4-n are depicted externally for convenience of explanation.

The NMS 5 includes, for example, a receiving unit 51 that receives various types of information from each optical node 4, a processing unit 52 that performs the above control based on the various types of information received, and a transmission unit 53 that sends control information based on the above control result to each optical node 4, as depicted in FIG. 18.

That is, the NMS 5 functions as an example of a control device of the optical transmission system 1′.

The processing unit 52 functions as an example of a controller that controllably expands the pass band for a known training signal in at least one optical node 4 through which the optical transmission path runs before transmission of the known training signal.

The processing unit 52 may be achieved using a processor and memory.

In addition, the processing unit 52 functions as an example of a processing unit that estimates the transmission path characteristics of the optical transmission path based on the transmission result of the known training signal transmitted in the optical transmission path after controllably expanding the pass band.

In the example depicted in FIG. 17, signal light sent from the Tx 2 is added by the optical node 4-1 to wavelength-multiplexed signal light transmitted in the optical transmission path, passes through the optical nodes 4-2 to 4-(n−1), is split (dropped) by the optical node 4-1, and is received by the Rx 3. The network topology of the optical transmission system 1′ illustrated in FIG. 17 is only an example and the optical transmission system 1′ may be ring-shaped, mesh-shaped, star-shaped, of fully-connected type, bus-shaped, tree-shaped, or so on. The optical transmission system 1′ may have a network topology formed by combination of these network topologies.

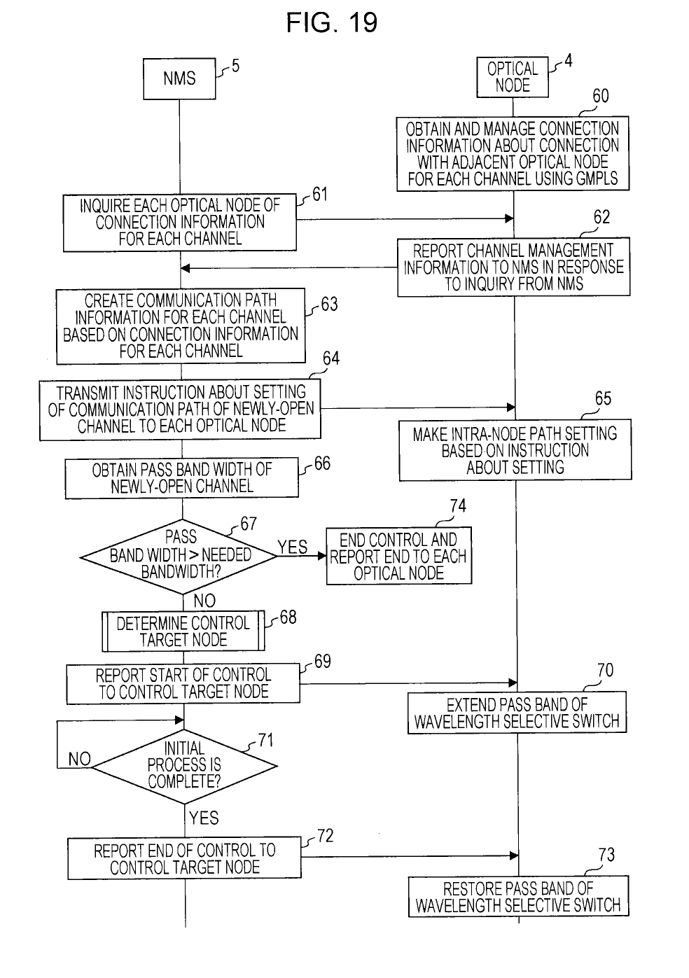

FIG. 19 depicts an example of a processing flow when the above control is performed using, for example, GMPLS in the optical transmission system 1′ depicted in FIG. 17.

In this case, as illustrated in FIG. 19, each optical node 4 first uses GMPLS to obtain connection information about connection between the local optical node 4 and an optical node 4 adjacent to the local optical node 4 for each channel and manages the obtained information about connection (operation 60). This connection information may include, for example, setting information for each channel in the WSS 43 of each optical node 4.

Then, the NMS 5 inquires each optical node 4 of the connection information for each channel (operation 61) and the each optical node 4 reports the connection information for each channel to the NMS 5 (operation 62).

Next, the NMS 5 creates communication path information for each channel based on the connection information for each channel reported from each optical node 4 (operation 63). This communication path information may include information indicating, for example, the optical node 4 to which signal light of each channel is added, the optical nodes 4 through which signal light of each channel passes, and the optical node 4 at which signal light of each channel is dropped.

In addition, the NMS 5 sends an instruction about setting of the WSS 43 of each optical node 4 to each optical node 4 based on the communication path of a newly-open channel (operation 64).

Each optical node 4 makes input/output settings (intra-node path settings) of the newly-open channel in the WSS 43 in the local optical node 4 based on the instruction reported from the NMS 5 (operation 65).

Next, the NMS 5 measures (obtains) the loss suffered by the training signal, the pass band width from the transmitter to the receiver in the newly-open channel, or so on through actual measurement or simulation (operation 66).

Then, the NMS 5 decides whether the obtained pass band width is larger than the desired bandwidth (operation 67). The desired bandwidth represents, for example, the pass band width desired for the training signal transmitted in the newly-open channel. The desired bandwidth may be determined based on a penalty acceptable value about the training signal or so on transmitted, for example, in the newly-open channel.

If the NMS 5 decides that the obtained pass band width is more than the desired bandwidth (Yes in operation 67), the NMS 5 ends the control and reports the end of the control to each optical node 4 (operation 74). When receiving the end of control, each optical node 4 starts transmitting the training signal without extending the pass band of the WSS 43 and performs the initial process.

If the NMS 5 decides that the obtained pass band width is equal to or less than the desired bandwidth (No in operation 67), the NMS 5 determines the control target node using the same method as in the control target node determination processing illustrated in FIG. 9 (operation 68).

Then, the NMS 5 reports the start of control to the control target node determined above (operation 69). The control target node 4 to which the start of control is reported extends the pass band width of a newly-open channel of the WSS 43 in the local optical node 4 (operation 70), transmits the training signal, and performs the initial process.

The NMS 5 decides whether the initial process is complete by receiving the completion report of the initial process from the optical node 4 that performs the initial process (operation 71). If the initial process is not complete (No in operation 71), the NMS 5 repeats the processing in operation 71.

On the other hand, if the NMS 5 decides that the initial process is complete (Yes in operation 71), the NMS 5 reports the completion of control to the control target node 4 (operation 72). When receiving the end of control, the control target node 4 restores the pass band width of a newly-open channel for the WSS 43 in the local optical node 4 (operation 73) and starts transmitting signal light in the newly-open channel.

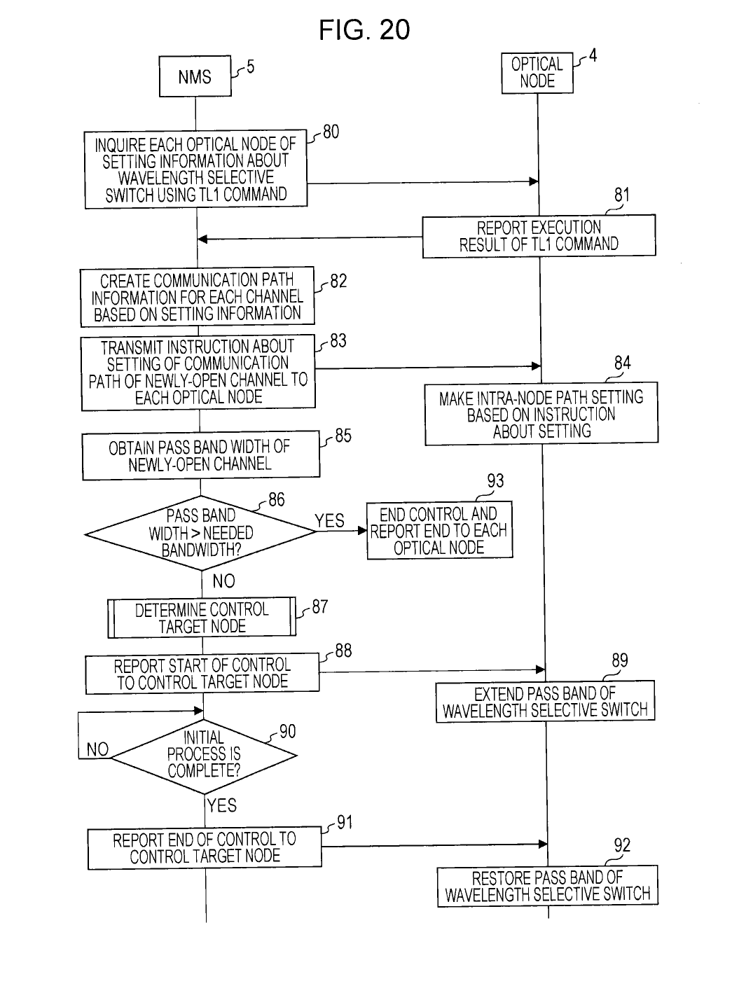

FIG. 20 depicts an example of a processing flow when the above control is performed using, for example, the TL1 command in the optical transmission system 1′ depicted in FIG. 17.

In this case, as illustrated in FIG. 20, the NMS 5 first inquires each optical node 4 of setting information about the WSS 43 in the local optical node 4 using the TL1 command (operation 80) and each optical node 4 reports the setting information to the NMS 5 as the execution result of the TL1 command (operation 81).

Next, the NMS 5 creates communication path information for each channel based on the setting information reported from each optical node 4 (operation 82). This communication path information may include information indicating, for example, the optical node 4 to which signal light of each channel is added, the optical nodes 4 through which signal light of each channel passes, and the optical node 4 at which signal light of each channel is dropped.

In addition, the NMS 5 sends an instruction about setting of the WSS 43 of each optical node 4 to each optical node 4 based on the communication path of a newly-open channel (operation 83).

Each optical node 4 makes input/output settings (intra-node path settings) of the newly-open channel in the WSS 43 in the local optical node 4 based on the instruction reported from the NMS 5 (operation 84).

Next, the NMS 5 measures (obtains) the loss suffered by the training signal or the pass band width from the transmitter to the receiver in the newly-open channel through actual measurement or simulation (operation 85).

Then, the NMS 5 decides whether the obtained pass band width is larger than the desired bandwidth (operation 86). The desired bandwidth represents, for example, the pass band width desired for the training signal transmitted in the newly-open channel. The desired bandwidth may be determined based on a penalty acceptable value about the training signal or so on transmitted, for example, in the newly-open channel.

If the NMS 5 decides that the obtained pass band width is more than the desired bandwidth (Yes in operation 86), the NMS 5 ends the control and reports the end of the control to each optical node 4 (operation 93). When receiving the end of the control, each optical node 4 starts transmitting the training signal without extending the pass band of the WSS 43 and performs the initial process.

If the NMS 5 decides that the obtained pass band width is equal to or less than the desired bandwidth (No in operation 86), the NMS 5 determines the control target node using the same method as in the control target node determination processing illustrated in FIG. 9 (operation 87).

Then, the NMS 5 reports the start of control to the control target node determined above (operation 88). The control target node 4 to which the start of control is reported extends the pass band width of a newly-open channel of the WSS 43 in the local optical node 4 (operation 89), transmits the training signal, and performs the initial process.

The NMS 5 decides whether the initial process is complete by receiving the completion report of the initial process from the optical node 4 that performs the initial process (operation 90). If the initial process is not complete (No in operation 90), the NMS 5 repeats the processing in operation 90.

On the other hand, if the NMS 5 decides that the initial process is complete (Yes in operation 90), the NMS 5 reports the completion of control to the control target node 4 (operation 91). When receiving the end of control, the control target node 4 restores the pass band width of a newly-open channel for the WSS 43 in the local optical node 4 (operation 92) and starts transmitting signal light in the newly-open channel.

As described above, in this example, the loss suffered by the training signal may also be reduced by extending the pass band of the training signal in the optical node 4 before transmitting training signal for estimating the transmission path characteristics of the optical transmission path.

As a result, the characteristics of an optical fiber can be estimated appropriately and parameters for digital signal processing can be set appropriately.

### 4 Others

The structures and functions of the optical transmission system 1 and 1′, the optical nodes 4, and the NMSes 5 in the above embodiment and modifications may be selected as occasion calls or may be combined as appropriate. That is, the above structures and functions may be selected or combined as appropriate to achieve the functions of the present disclosure.

In the first modification described above, for example, the optical node 4 in which an addition or drop is performed in one of both adjacent channels adjacent to the channel in which the training signal is transmitted is determined not to be controlled. However, except when both adjacent channels are added or dropped, the optical node 4 may be determined to be controlled. In this case, the pass band for the training signal may be extended to the adjacent channel that is not added or dropped. That is, the pass band controller 46 or the NMS 5 may have a function of determining the direction in which the pass band of the control target channel is extended, depending on the state of the adjacent channel.

Additional Note for Embodiments

Note 1. An optical transmission system, that includes a plurality of optical transmission devices and estimates transmission path characteristics of an optical transmission path running from one optical transmission device to another optical transmission device through at least one optical transmission device based on a result of transmitting a known symbol sequence in the optical transmission path, the optical transmission system comprising: a controller that controllably extends a pass band for the known symbol sequence in at least one optical transmission device through which an optical transmission path runs from one optical transmission device to another optical transmission device; and a processing unit that estimates the transmission path characteristics of the optical transmission path based on the result of transmitting the known symbol sequence in the optical transmission path after the controller controllably extends the pass band.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A control method for an optical transmission system, the control method comprising:
controllably extending a pass band for transmission of a known symbol sequence in at least one optical transmission device;
transmitting the known symbol sequence in an optical transmission path between one optical transmission device to another optical transmission device through the at least one optical transmission device; and
estimating the transmission path characteristics of the optical transmission path, based on a result of the transmitting.

2. The control method for the optical transmission system according to claim 1, wherein
the extended pass band is controllably restored upon completion of the estimating, and
settings for digital signal processing in the at least one of the one optical transmission device, the at least one optical transmission device through which the optical transmission path runs, and the other optical transmission device are made, based on a result of the estimating.

3. The control method for the optical transmission system according to claim 1, wherein
the pass band of the at least one optical transmission device through which the optical transmission path runs is controllably extended so that the transmitted known symbol sequence satisfies a predetermined reception quality in the other optical transmission device.

4. The control method for the optical transmission system according to claim 1, wherein
a number of optical transmission devices for which the pass band is controllably extended is determined based on a number of the at least one optical transmission device through which the optical transmission path runs.

5. The control method for the optical transmission system according to claim 1, wherein
the pass band of an optical transmission device for which an adjacent channel adjacent to a channel in which the known symbol sequence is transmitted is not used is determined to be controllably extended among the at least one optical transmission device through which the optical transmission path runs.

6. The control method for the optical transmission system according to claim 1, wherein
the pass band of an optical transmission device for which signal light is inserted or split in an adjacent channel adjacent to a channel in which the known symbol sequence is transmitted is determined not to be controllably extended among the at least one optical transmission device through which the optical transmission path runs.

7. The control method for the optical transmission system according to claim 1, wherein,
when the optical transmission system includes a ring network, the optical transmission device for which the pass band is controllably extended is determined so that leak light caused by controllably extending the pass band does not go around the ring network.

8. The control method for the optical transmission system according to claim 1, wherein
the at least one optical transmission device through which the optical transmission path runs has a wavelength selective switch and,
in the wavelength selective switch, the pass band is controllably extended by extending a pass band of a channel in which the known symbol sequence is transmitted to a pass band of an adjacent channel adjacent to the channel in which the known symbol sequence is transmitted.

9. The control method for the optical transmission system according to claim 1, wherein
the at least one optical transmission device through which the optical transmission path runs has a wavelength selective switch of liquid crystal on silicon type and,
in the wavelength selective switch of liquid crystal on silicon type, the pass band is controllably extended by setting an adjacent channel adjacent to a channel in which the known symbol sequence is transmitted to a pass state.

10. The control method for the optical transmission system according to claim 1, wherein
a bandwidth of the known symbol sequence is larger than a bandwidth of signal light.

11. An optical transmission device, comprising:
a controller that controllably extends a pass band of an optical transmission path for transmission of a known symbol sequence; and
a transmission processing unit that provides the known symbol sequence after the controller controllably extends the pass band.

12. The optical transmission device according to claim 1, wherein
the known symbol sequence is a training signal.

13. The optical transmission device according to claim 1, wherein
the known symbol sequence is a training signal in which 0 and 1 appears alternately.

14. A control device that estimates transmission path characteristics of an optical transmission path running from one optical transmission device to another optical transmission device through at least one optical transmission device based on a result of transmitting a known symbol sequence in the optical transmission path, the control device and a plurality of optical transmission devices being included in an optical transmission system, the control device comprising:
a controller that controllably extends a pass band for the known symbol sequence in the at least one optical transmission device through which the optical transmission path runs; and
a processing unit that estimates the transmission path characteristics of the optical transmission path based on the result of transmitting the known symbol sequence in the optical transmission path after the controller controllably extends the pass band.

15. An optical transmission system that includes a plurality of optical transmission devices and estimates transmission path characteristics of an optical transmission path running from one optical transmission device to another optical transmission device through at least one optical transmission device based on a result of transmitting a known symbol sequence in the optical transmission path, the optical transmission system comprising:
a control device that includes
a controller that controllably extends a pass band for the known symbol sequence in the at least one optical transmission device through which the optical transmission path runs, and
a processing unit that estimates the transmission path characteristics of the optical transmission path based on the result of transmitting the known symbol sequence in the optical transmission path after the controller controllably extends the pass band.
